(19) United States
(12) Patent Application Publication
(10) Pub. No.: US 2005/0033771 A1
(43) Pub. Date: Feb. 10, 2005

(54) Contextual advertising system

(76) Inventors: Thomas A. Schmitter, New York, NY (US); James S. Rosen, New York, NY (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 10/836,820

(22) Filed: Apr. 30, 2004

Related U.S. Application Data
(60) Provisional application No. 60/466,576, filed on Apr. 30, 2003.

(51) Int. Cl. G06F 17/00

(52) U.S. Cl. 707/104.1

(57) ABSTRACT

A system analyzes a user's historic browsing activity to determine one or more topics of interest to the user and displays to the user one or more advertisements that are relevant to the user's topic(s) of interest. The system analyzes a plurality of browses to determine the user's interest(s). Each of a plurality of analyzers analyzes an aspect of each user browse. A relevance filter determines if and when the user is sufficiently interested in a topic to display an advertisement related to the topic. Once the relevance filter identifies a topic of interest, the system displays an advertisement that is related to the identified topic of user interest.

### CROSS REFERENCE TO RELATED APPLICATIONS

This application claims the benefit of U.S. Provisional Application No. 60/466,576 titled “System and Method for Online Contextual Marketing,” filed Apr. 30, 2003.

### STATEMENT REGARDING FEDERALLY SPONSORED RESEARCH OR DEVELOPMENT

(Not applicable)

### BACKGROUND OF THE INVENTION

1. Field of the Invention

The present invention relates to on-line advertising systems and, more particularly, to such systems that select advertisements based on a history of a user's browsing behavior.

2. Description of the Prior Art

Some advertisers use on-line systems in attempts to deliver “targeted” advertisements to computer users while the users browse web pages on the Internet. Advertisements are believed to be effective when there is a correlation between the subject matter of the advertisements and interests of the target audience. Targeted advertising systems attempt, therefore, to determine current interests of users, so the systems can display one or more advertisements that relate to these interests.

One type of existing system bases its determination of the user's current interests on the web page the user is currently viewing. (Each page is uniquely identified by a “uniform resource locator” or URL.) The user is presumed to be interested in subject matter related to topics displayed on the currently viewed web page. A system based on this presumption displays advertising that is related to the subject matter of the currently viewed web page. Some such systems display advertisements for competitors of the owners of the current web page. Other such systems display advertisements for products or services that complement those of the current web page. For example, if the current web page relates to sports cars, an advertising system could display an advertisement for a competing brand of sports car, high-performance tires or cologne that is thought to be of interest to people who are interested in sports cars.

In another existing type of advertising system, if the user visits a search engine web site, the search query the user enters into the search engine is used to ascertain the user's current interests. In such a system, each advertisement is associated with one or more unique keywords (including key phrases). If a user enters a search query that contains one of the keywords, the system displays an advertisement associated with that keyword. Thus, existing targeted advertising systems use the URL of the currently viewed web page or the current search query to select an advertisement for display to the user.

A typical existing targeted advertising system installs a program on a user's computer, so the program can run in the background and intercept user inputs while the user browses the Internet. The program obtains the URL of the currently displayed page or the search query entered by the user. (This information is known as “click-stream data.”) As the user browses, the program sends the click-stream data in real time over the Internet to a central server for analysis. At the server, the URL is compared to a list of predefined URLs to determine if an advertiser has paid to have an advertisement displayed along with the page the user is currently viewing. Similarly, the server compares the search query to a predefined list of keywords to determine if an advertiser has paid to have an advertisement displayed in association with the word or phrase the user entered into a search engine. If a URL or keyword match occurs, the server sends an appropriate advertisement back over the Internet to the program, which then displays the advertisement, such as in a pop-up window.

URL-mapped advertising can be effective, if an advertiser can identify one or more specific competitors' web pages and the competitors are in all the same markets as the advertiser. If, however, the competitor is more diversified than the advertiser, the user might visit the web page in relation to a product or service that is not offered by the advertiser. In this case, the displayed advertisement is not likely to be effective. URL-mapped advertising is also ineffective in cases where the user seeks information about a product or service, but is unaware of a specific supplier's web page.

Some on-line advertising systems group URLs into categories. If a user visits any web page of a defined category, the system displays an advertisement associated with the category. This can, however, lead to an unfocused advertising campaign, especially if web pages can each be listed in plural categories or if web page contents are dynamic and change over time.

Keyword-based advertising systems can also deliver misguided advertising. For example, a given keyword might have different meanings in different contexts, yet conventional advertising systems are incapable of distinguishing among these contexts. For example, a search query that includes the word “snow” might be related to one of a wide range of topics, including winter sports, snow plowing, tires, road conditions or weather forecasts.

Thus, conventional advertising systems can not determine a user's interests with sufficient accuracy to deliver targeted advertisements. Furthermore, many users have voiced privacy concerns over their click-stream data being collected by central servers. These concerns have led many users to remove the background programs from their computers. In addition, pop-up advertisements are almost universally unpopular with users. Many users deem pop-up advertisements to be disruptive and, as noted, they are often irrelevant. Advertisements delivered by conventional targeted advertising systems are, therefore, usually dismissed and ignored by users.

### BRIEF SUMMARY OF THE INVENTION

The present invention provides methods and apparatus for analyzing a user's historic browsing activity to determine one or more topics of interest to the user and for displaying to the user one or more advertisements that are relevant to the user's topic(s) of interest. Embodiments of the present invention analyze a plurality of browses to determine the user's interest(s). Each of a plurality of analyzers analyzes an aspect of each user browse. For example, user inputs, such as search queries or text of invoked hyperlinks, as well as outputs, such as web page titles, are analyzed for evidence of user interest in various topics. Each time one of the analyzers detects evidence of user interest in a topic, the analyzer contributes a topic nomination. A relevance filter analyzes the topic nominations to determine if and when the user is sufficiently interested in a topic to display an advertisement related to the topic. Once the relevance filter identifies a topic of interest, the system displays an advertisement that is related to the identified topic of user interest.

### BRIEF DESCRIPTION OF THE SEVERAL VIEWS OF THE DRAWINGS

These and other features, advantages, aspects and embodiments of the present invention will become more apparent to those skilled in the art from the following detailed description of an embodiment of the present invention when taken with reference to the accompanying drawings, in which the first digit, or first two digits, of each reference numeral identifies the figure in which the corresponding item is first introduced and in which:

FIG. 1 is a conceptual block diagram of one embodiment of the present invention;

FIG. 2 is a more detailed block diagram of an embodiment of the present invention;

FIG. 3 is a simplified block diagram of a score calculator of FIG. 2;

FIG. 4 is a simplified database schema of the database of FIG. 2;

FIG. 5 is an exemplary list of detection type factors that can be used by the embodiment of FIG. 2;

FIGS. 6A and 6B contain a simplified flowchart of operations performed by one embodiment of the present invention;

FIG. 7 is an exemplary list of history weighting factors that can be used by the embodiment of FIG. 2;

FIG. 8 is a subset of an exemplary database used in the scenario of FIGS. 9A-D;

FIGS. 9A-D depict a series of exemplary browser windows resulting from an exemplary scenario of user browses;

FIG. 10 is an exemplary score log produced by the scenario of FIGS. 9A-C;

FIG. 11 is a simplified flowchart of operations performed to update the database of FIG. 4; and

FIG. 12 is an exemplary browser window with hypertext displayed, according to another embodiment of the present invention.

### DETAILED DESCRIPTION OF THE INVENTION

The present invention provides methods and apparatus for analyzing a user's historic browsing activity to determine one or more topics of interest to the user and for displaying to the user one or more advertisements that are relevant to the user's topic(s) of interest. Embodiments of the invention display particularly relevant advertisements in a scrollable region of the user's browser. Some embodiments display relevant advertisements in a scrollable pop-under window. Other embodiments analyze data that is displayed to the user and convert relevant data into hyperlinks, which the user can invoke to display related advertisements.

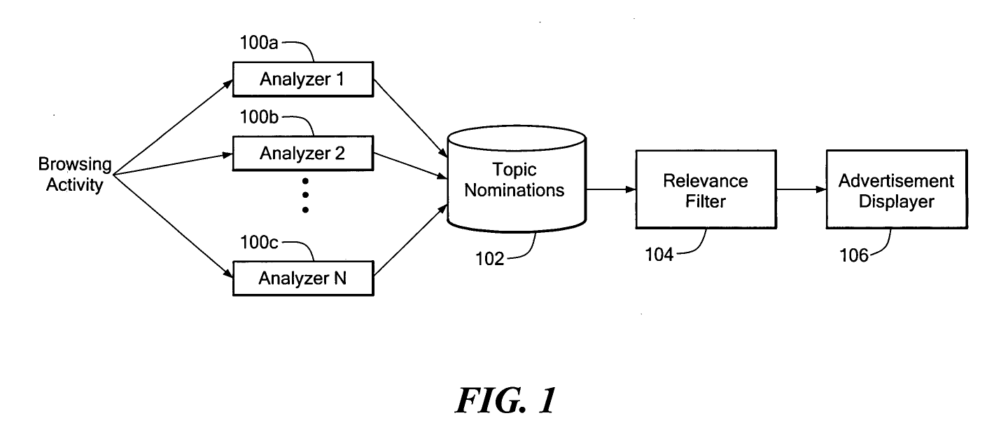

As noted, analyzing a single user interaction (browse) in an attempt to determine a user's interest(s), as is done in the prior art, is insufficient to select an appropriate targeted advertisement. In contrast, embodiments of the present invention analyze a plurality of browses to determine the user's interest(s). FIG. 1 illustrates some of the concepts underlying the present invention. At least one analyzer 100a-n analyzes the user's browsing activity. Each analyzer 100 can analyze a different aspect of the browsing activity, although there can be overlap among the aspects analyzed and criteria used by the analyzers. When an analyzer 100 detects evidence of user interest in a topic, the analyzer contributes a topic nomination to a memory 102. For example, one analyzer 100 a can search for keywords in titles of data displayed to the user, and another analyzer 100b can analyze search queries entered by the user into search engines. One or more of the analyzers 100 can contain web page-specific logic, for example to parse text displayed by the page.

Typically, a single topic nomination is insufficient to trigger an advertisement. As the user browses, additional nominations are added to the memory 102. Thus, the system accumulates information related to a plurality of browses by a client. A relevance filter 104 determines if and when the user is sufficiently interested in a topic to display an advertisement related to the topic. The relevance filter 104 can also estimate a level of user interest in the topic.

The user can, of course, change interests as he/she browses. To accommodate these changes, the relevance filter 104 can, for example, favor recent topic nominations and discount older nominations.

Once the relevance filter 104 identifies a topic of interest, an advertisement displayer 106 displays an advertisement that is related to the identified topic. Thus, the advertisement is selected based on the accumulated information. Based on the relevance filter's 104 determination of the user's level of interest in the topic, the advertisement can be displayed in one of several modes. For example, high-interest advertisements can be displayed in a scrollable region of the user's browser, whereas lower-interest advertisements can be displayed in a pop-under window.

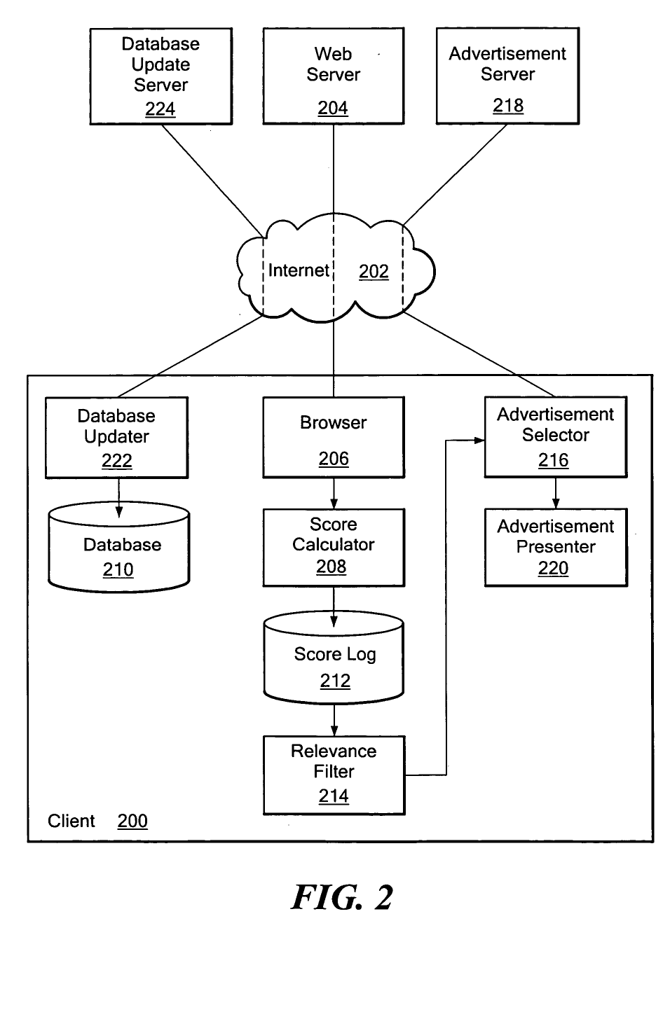

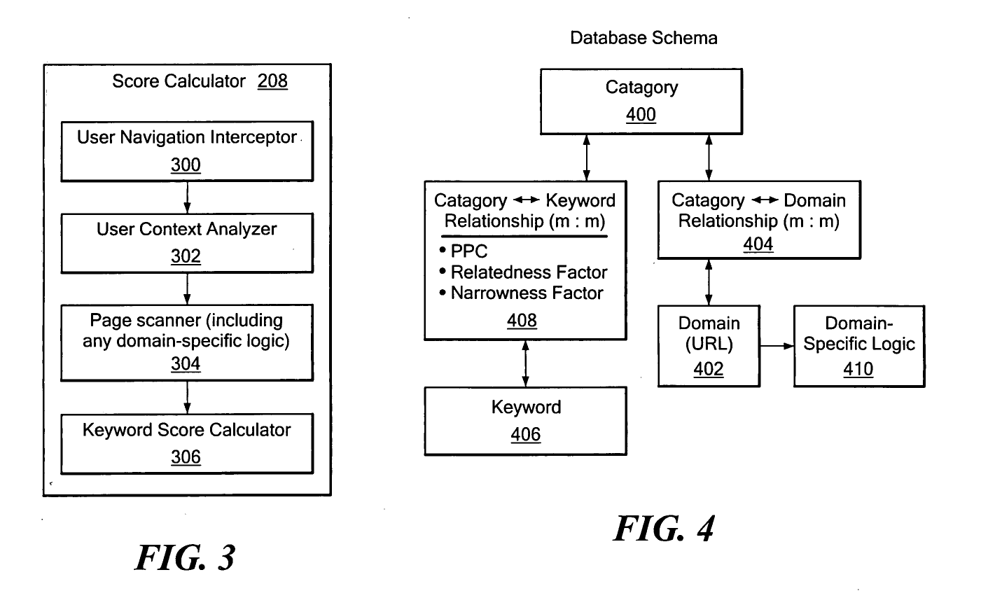

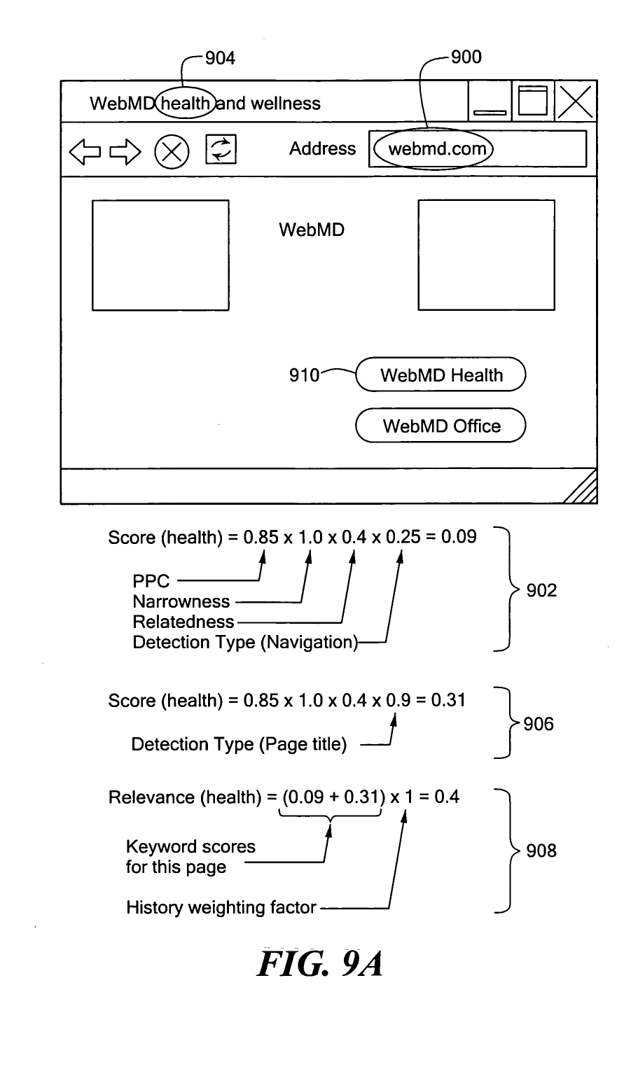

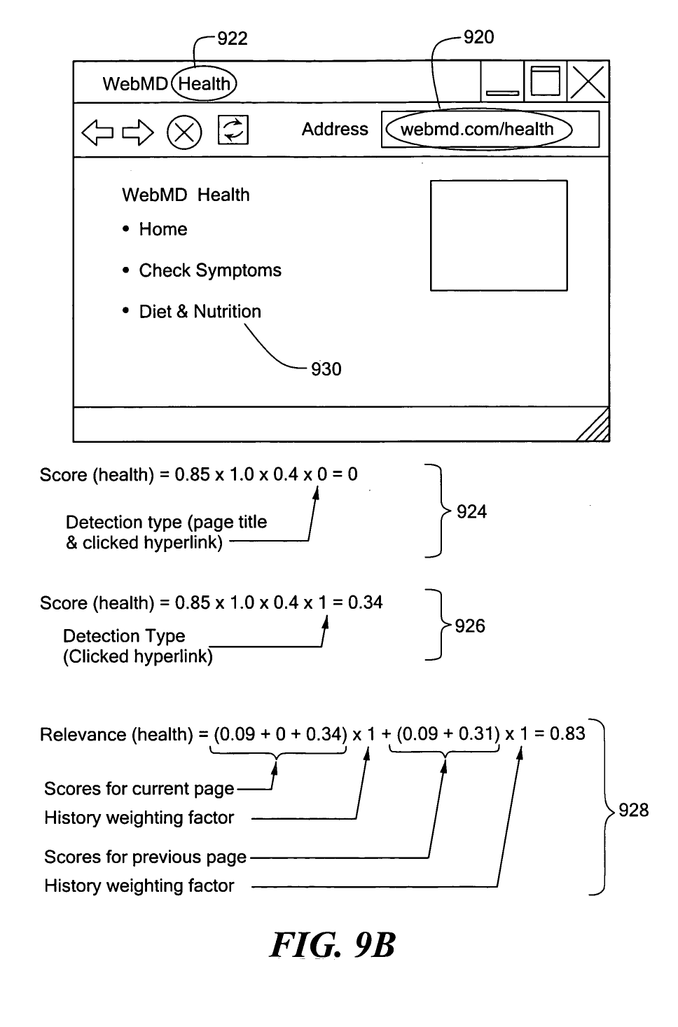

Many embodiments are possible for the analyzers 100, relevance filter 104 and other components of FIG. 1. One embodiment will be described in detail for use with conventional browsers, such as Microsoft Internet Explorer or Netscape Navigator, and the Internet. This and other embodiments can also be used with other browsers, intranets, private data networks and other on-line systems, as will be described in detail below. An overview of the embodiment will be presented with reference to FIG. 2, followed by a more detailed description of the embodiment with reference to FIGS. 3-7. This is followed by an example scenario, which is described with reference to FIGS. 8, 9A-D and 10.

FIG. 2 is a block diagram of the embodiment and a context in which the embodiment can be advantageously practiced. A client computer 200, such as a personal computer (PC), is connected via the Internet 202 to a web server 204. Using a browser 206, the client 200 can browse the Internet 202 and request and display or otherwise process web pages or other data (collectively referred to hereinafter as pages) provided by the web server 204 and other servers (not shown) connected to the client via the Internet or otherwise.

In this embodiment, a score calculator 208 contains the analyzers 100 described above with respect to FIG. 1. The score calculator 208 uses information (such as page categories and corresponding keywords, which are described in detail below) stored in a database 210 to analyze the user's browsing. For example, the score calculator 208 can scan user-entered search queries, text of invoked hyperlinks and page titles for keywords. When the score calculator 208 detects evidence of user interest in a topic, i.e. a keyword, the score calculator stores a topic nomination in a score log 212. Each topic nomination includes a keyword and a score, as described in detail below. A relevance filter 214 compares cumulative scores, i.e. scores collected over several browses, for each keyword in the score log 212 to threshold values. The relevance filter 214 preferably includes logic to discount older topic nominations. If a keyword's cumulative score exceeds a threshold value, an advertisement selector 216 sends the keyword via the Internet 202 to an advertisement server 218. Such an advertisement service is available from Overture Services, Inc., Pasadena, Calif. The advertisement server 218 returns an advertisement related to the keyword, and an advertisement presenter 220 displays the advertisement to the user. Preferably, to update the database 210 with new or changed page categories, keywords, etc., a database updater 222 periodically, occasionally or on command updates the database 210 over the Internet 202 from a database update server 224.

Although the described embodiment utilizes both categories of pages and keywords to ascertain topics of interest to users, other embodiments can use a category-based taxonomy, i.e. without keywords, or other taxonomies to evaluate user browses. In a category-based system, scores are calculated for categories, and advertisements are returned by the advertisement server in response to category-based requests, rather than keyword-based requests.

A more detailed description of the embodiment of FIG. 2 will now be presented with reference to FIGS. 3-7. FIG. 3 is a block diagram of one embodiment of the score calculator 208. A user navigation interceptor 300 uses a well-known interface to plug into an object model of the browser 206 to gain access to user inputs into the browser, notifications of events, data sent by servers to the browser, etc. For example, Microsoft Internet Explorer provides an interface that is accessible via a loadable dynamic link library (DLL). Other browsers provide similar application programming interfaces (APIs). A user context analyzer 302 analyzes the user navigations, as described in more detail below. The navigation interceptor 300 provides an interface between the browser 206 and the user context analyzer 302. That is, the user context analyzer 302 uses the navigation interceptor 300 to be notified of user browses and to obtain information about the browses. A user context analyzer 302 uses the database 210 to identify one or more keywords associated the currently displayed page. A page scanner 304 scans the user's browse for occurrences of the keywords. If the page scanner 304 detects evidence of the user's interest in a topic, i.e. the page scanner finds a keyword in the user's browse, a keyword score calculator 306 stores information about the topic and a score indicating a level of confidence in this detection in the score log 212.

The user can navigate to a page in various ways, including: entering the URL of the page into the browser 206 or into another component (not shown), selecting a stored URL (commonly referred to as a “favorite” or “bookmark”), invoking a hyperlink (such as one contained on a web page, e-mail message, word processing document, database or elsewhere) or entering a search query into a search engine. In general, once the user issues a navigation command, the browser 206 is used to display a page, even if the user issued the navigation command in another component. Although other components, such as word processors, e-mail programs and the like, can be used to display pages, for simplicity, this embodiment is described in the context of the browser 206. This description also applies to situations in which other components receive page data from servers. Browsing is not, however, limited to Internet pages or public Internet search engines. Users can browse any data that can be identified by a URL or otherwise, including data stored on the client or on a private server. Furthermore, the score calculator 208 is not restricted to analyzing user inputs (navigations). The score calculator can also analyze data that is returned by a server, such as for display or use by the browser 206. Thus “browsing” in the context of the present invention includes both user inputs (such as URLs, text of invoked hyperlinks and search queries) and data from servers (such as page titles, displayed text, meta-tags and formatting commands), as well as any other data available to the score calculator 208.

When the user navigates to a page, the user context analyzer 302 ascertains a top-level domain and a second-level domain (collectively hereinafter referred to as the “domain”) of the page and assigns a category to the page based on the domain. The database 210 contains domain-to-category relationship information to facilitate this assignment.

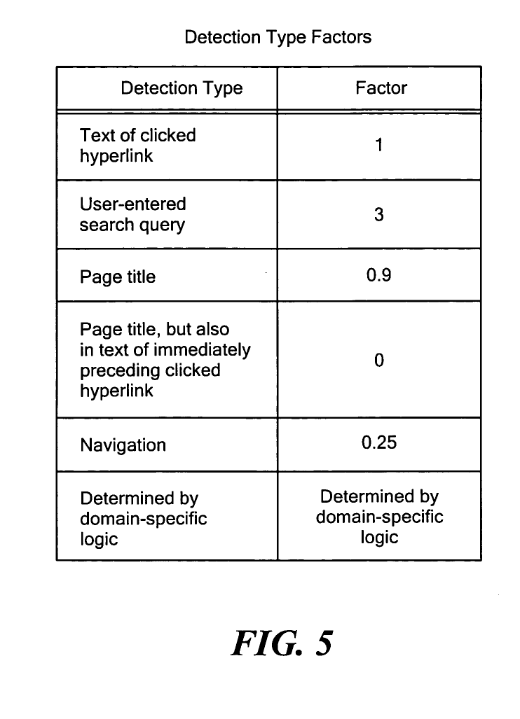

FIG. 4 is a simplified schema diagram of a preferred embodiment of the database 210, which is preferably a relational database. A category table 400 contains a row (record) for each category. Similarly, the domain table 402 contains a row for each domain. A category-to-domain relationship table 404 contains a row for each category in each domain. This row links the appropriate category row with the appropriate domain row, as is well-known in the art. The category-to-domain table 404 establishes a many-to-many relationship between categories and domains.

The database 210 also contains a list of one or more keywords for each category. From the database 210, the user context analyzer 302 obtains a list of keywords associated with the domain of the currently displayed page. Referring again to FIG. 4, a keyword table 406 contains a row for each keyword. A category-to-keyword relationship table 408 contains a row for each keyword in each category. This row links the appropriate category row with the appropriate keyword row. The category-to-keyword table 408 establishes a many-to-many relationship between keywords and categories. Thus, for example, the keyword “mustang” can have separate relationships to categories “sports cars” and “horses.”

Each category-to-keyword row includes metrics for the associated keyword. These metrics are used to calculate a score for the keyword in the context of the associated category. These metrics can include a price per click (PPC), which represents the market value of a keyword. These metrics also preferably include a relatedness factor and a narrowness factor. The relatedness factor indicates the strength of the relationship between a keyword and its category. For example, the keywords “car,” “SUV” and “auto-parts” are more closely related to the “automobile” category than the keywords “financing,” “repairs” or “lease.” The narrowness factor indicates the amount of ambiguity (or lack thereof) in the keyword. For example, the keyword “health” is not narrowly focused; this keyword can apply to a wide range of topics, including herbal remedies, hearing aids and exercise equipment. On the other hand, the keyword “Viagra” is narrowly focused.

Since the user chooses the pages to which the user navigates, the user is presumed to be interested in the contents of these pages. An occurrence of one or more of the keywords in the user's browses is, therefore, taken as evidence of the user's interest in these keywords. The more frequently a keyword occurs in the user's browses, the higher the user's interest is in the associated topic. Thus, when the user navigates to a page, the context analyzer 302 looks up the category(ies) associated with the domain of the visited page. The context analyzer 302 also looks up the keyword(s) associated with the category of the visited domain. The page scanner 304 scans the user's browses (user inputs and server outputs) for these keywords. If the page scanner 304 detects a keyword, such as in a title of a page displayed by the browser 206 or in a search query entered by the user into a search engine, the keywords score calculator 306 uses the metrics in the category-to-keyword relationship table 408 to calculate a score for that occurrence of the keyword. The keyword and score are then stored in the score log 212. If a keyword occurs more than once in a single user browse, for example in a title of the currently displayed page and in a user-entered search query, the keyword and its corresponding score are stored in the score log 212 once for each such occurrence.

In a category-based taxonomy, or other taxonomies, scores are calculated for the categories or other attributes of the user's browses. In these cases, the database can store metrics in association with the categories or other attributes and possibly dispense with storing the keyword data.

The keyword score can be calculated in many ways. In one embodiment, the keyword score is calculated according to the following formula.
Score=PPC×Relatedness Factor×Narrowness Factor×Detection Type Factor

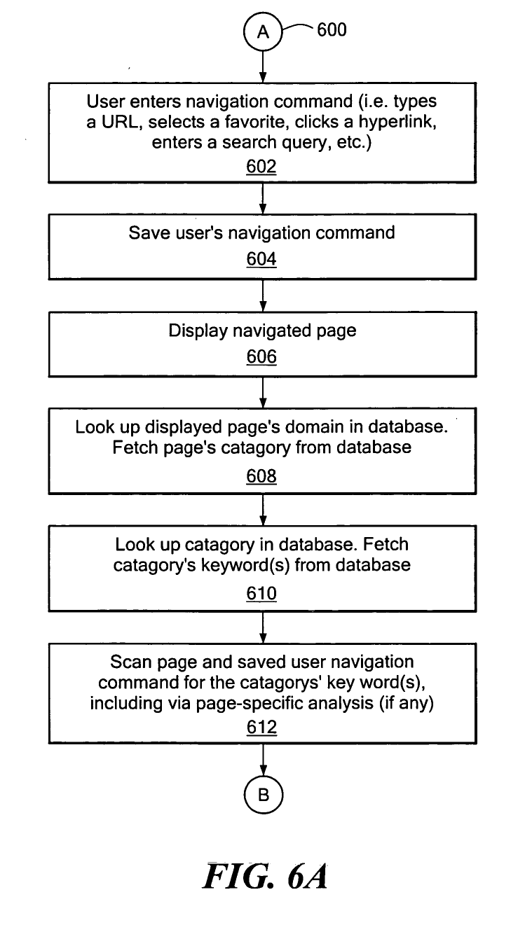

The detection type factor depends on where the keyword was detected in the user's browse. FIG. 5 contains a table of preferred detection types and their corresponding preferred factors. For example, if the keyword is detected within the text of a hyperlink that the user invoked to navigate to the current page, the detection type is “Text of clicked hyperlink,” and the detection type factor is 1. If the keyword is found in a user-entered search query, the detection type factor is 3. If the keyword is found in the title of the currently displayed page, the detection type factor is 0.9. If, however, the keyword is found in the title of the currently displayed page and within the text of a hyperlink that the user invoked to navigate to the current page, the detection type factor is 0. Alternatively, a very small value can be used.

The page scanner 304 can also detect keywords “implicitly,” i.e. by virtue of the fact that the user navigated to a given page. For example, as previously noted, each category has one or more associated keywords. When the user navigates to a page, the page scanner 304 can implicitly find all the keywords associated with that page's category, even if the keywords do not actually appear in the title of the page, in the hyperlink that the user invoked to navigate to the current page or elsewhere in the page. This detection type is labeled “Navigation” in the table of FIG. 5.

The page scanner 304 can include page-specific or domain-specific logic. For example, if the currently displayed page is a results page produced by a shopping-related search engine, page-specific logic (which was written with some knowledge of the layout of the results page) can parse the results page looking for occurrences of a keyword in portions of the page that are deemed to be significant. The specific logic can also calculate keyword scores in a page- or domain-specific way. This domain-specific logic can be stored in the database 212, as indicated at 410. Other embodiments can include category-specific, keyboard-specific, or other specific logic.

Optionally or additionally, relatedness factors, narrowness factors or other metrics can be stored in the category-to-domain table 404 or other tables of the database 212, and these metrics can be used instead of, or along with, the factors in the category-to-keyword table 408 to calculate scores. Other embodiments can, of course, use different or additional detection types or factors.

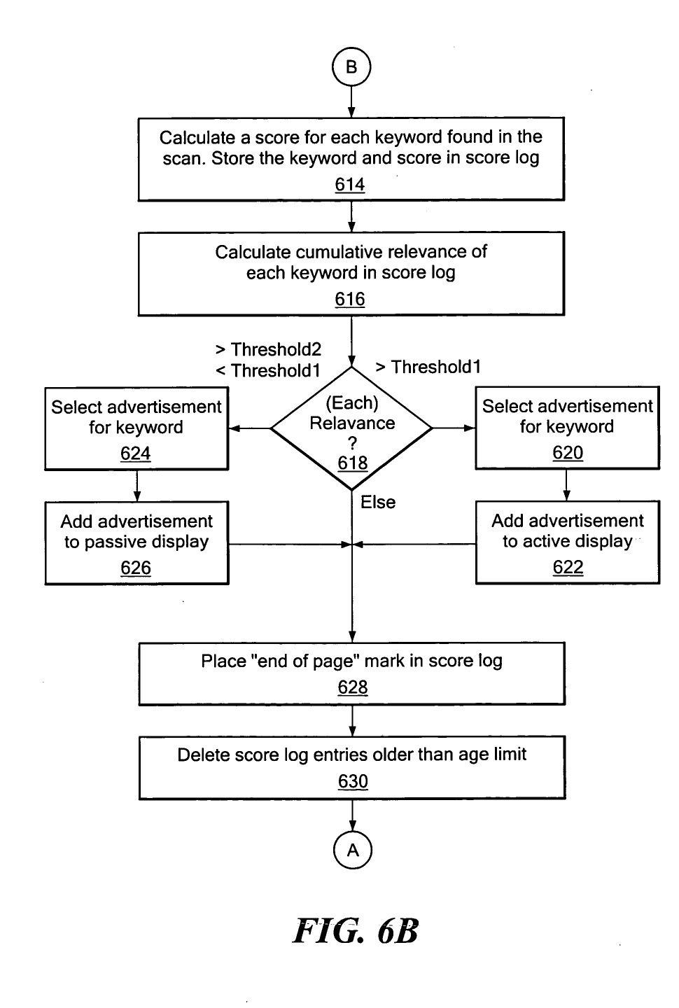

FIGS. 6A and 6B provide a simplified flowchart of processing performed by an embodiment of the present invention. The flowchart begins at 600. At 602, the user enters a navigation command. For example, the user can enter a URL, select a favorite, invoke a hyperlink or enter a search query. At 604, the user's navigation command is saved. The saved information includes the type of navigation command that was entered. This type information will be used to select an appropriate detection type factor. The saved information also includes the text of a hyperlink (if the user invoked a hyperlink) or a search query (if the user entered a search query). Because it is not always possible to identify text entered by the user as a search query, all text sent by the browser to a server can be saved and later all or part of the text can be analyzed.

At 606, the navigated page is displayed. At 608, the domain of the displayed page is used to fetch the page's category from the database. At 610, the currently displayed page's category is used to fetch keywords associated with the category from the database.

At 612, the user's browse and the information saved at 604 is scanned for the keywords. In one embodiment, the page's title and the information saved in 604, i.e. text of an invoked hyperlink and user-entered search query, is scanned. In other embodiments, other aspects of the user's browse, including meta-tags returned by the server, can be scanned. In addition, searches and keyword scoring performed by domain-specific logic are conducted at 612. Alternatively, rather than saving user-entered search queries at 604, domain-specific logic can parse results pages displayed by search engines for the search query at 612. All the keywords associated with the currently displayed page are also implicitly found at 612, as previously discussed.

At 614, a score is calculated for each keyword found in the scan of 612. The scores and the associated keywords are stored in the score log, along with an indication of the keyword's detection type. Preferably, additional information is stored in the score log 212 to enable an “age” of each keyword's score to be determined. For example, keyword scores calculated for the currently displayed page could have an age of 0; keyword scores calculated for the previously displayed page could have an age of −1; keyword scores calculated for the page immediately prior to the previously displayed page could have an age of −2; and so forth.

At 616, a cumulative relevance score is calculated for each keyword in the score log. This cumulative relevance score takes into account the user's previous browses. The calculation of the cumulative relevance score preferably weights more recent keyword scores more heavily than older keyword scores. The cumulative relevance score can be calculated in many ways. In one embodiment, a cumulative relevance score for a given keyword is calculated according to the following formula.
Relevance=Sum[H(n)×Score(n)], n=0 to Age Limit

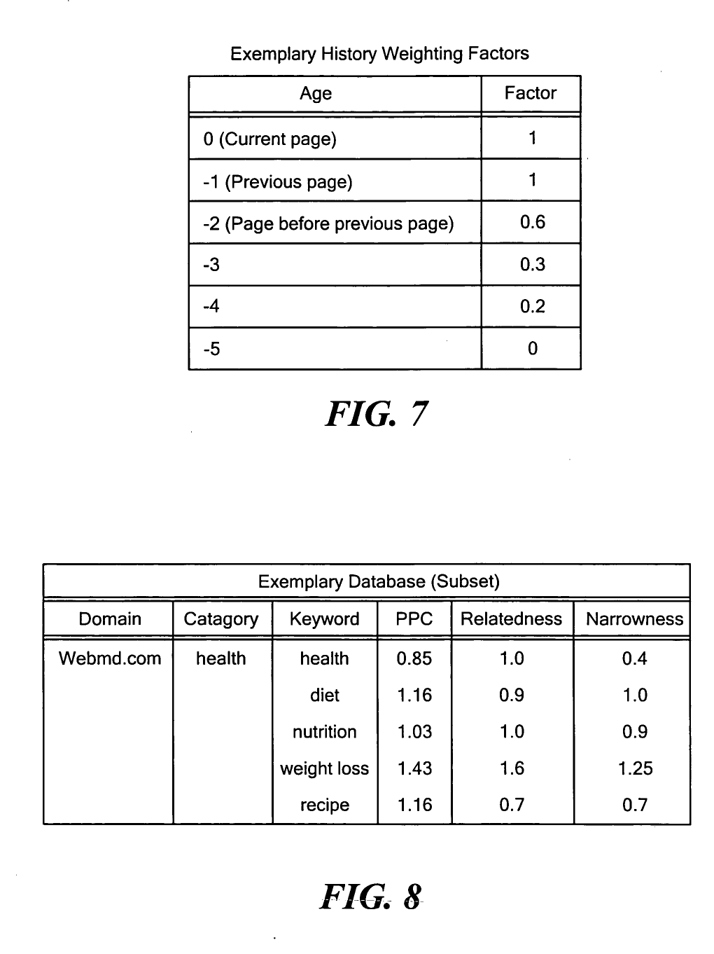

H(n) is a history weighting factor, which diminishes the significance of older keyword scores. Discounting older keywords favors topic nominations that are created close together in time and disfavors topic nominations that are more scattered over time. Exemplary values for this function are shown in FIG. 7. One set of history weighting factors can be used for all cumulative relevance calculations. Alternatively, separate sets of history weighting factors can be defined per keyword (and stored in the keyword table 406 ), per category-to-keyword relationship (and stored in a category-to-keyword table 408 ), or otherwise. S(n) is the score for the keyword having age “n” and stored in the score log. The “Age Limit” is preferably −4 to allow the calculation to take into consideration the currently displayed page and the four immediately previous pages, although other age limits are acceptable.

At 618, the cumulative relevance score for each keyword is compared to preferably two thresholds. If the cumulative relevance score exceeds the larger of the two thresholds (“Threshold1” in FIG. 6B), control passes to 620, where an advertisement is selected based on the keyword, and at 622, the advertisement is added to an “active” display. The active displayed is preferably a separate, scrollable frame in, and near the bottom of, the browser window. This frame can display a plurality of advertisements. If this frame does not yet exits, one is created. If this frame already exists, the advertisement is added to the frame. Optionally, the user can close this frame by clicking on a traditional windows close (“X”) button in the frame. Optionally, the active display is separate from the browser, such as a pop-up window.

At 618, if the cumulative relevance score is between the smaller of the two thresholds (“Threshold 2” in FIG. 6B) and the larger threshold, control passes to 624, where an advertisement is selected based on the keyword. At 626, the advertisement is added to a “passive” display. The passive display is preferably a separate, scrollable pop-under window. This window can display a plurality of advertisements. Optionally, the user can close this window by clicking on a traditional windows close (“X”) button in the window. Optionally, a status message is displayed in the status bar of the browser indicating that an advertisement is available for viewing in the pop-under window.

If the cumulative relevance score is less than both thresholds, control passes to 628. At 628, an “end of page” marker is placed in the score log to demarcate scores related to the current browse. At 630, keyword scores older than the age limit are purged from the score log, and control returns to 600 to await the next user navigation command.

As the user browses among domains or among categories of domains, keywords from previously visited categories or domains preferably continue to be used while searching subsequent browses. A limit can be set on the number of sets of keywords used simultaneously by the system. Alternatively or in addition, older keywords can be discounted using another set of history weighting factors, similar to those shown in FIG. 7.

FIGS. 8, 9A-D and 10 provide an example scenario of the operation of one embodiment of the present invention. FIG. 8 shows an exemplary subset of the database 210. In this example, the domain “webmd.com” is associated with the category “health.” This category has five associated keywords: “health,” “diet,” “nutrition,” “weight loss” and “recipe.” These keywords have PPCs, relatedness factors and narrowness factors as shown in the figure. FIGS. 9A-D show a series of browser windows as the user navigates a series of pages in this domain. For this scenario, assume the user enters the URL “webmd.com” into the browser as the user's first browse. In response, the browser displays a window similar to the one shown in FIG. 9A. The domain is determined to be “webmd.com” from the URL 900. The category of the page is determined to be “health” from the domain, and the five keywords are fetched from the database.

As shown at 902, a score for the keyword “health” is calculated, because the user navigated to a page for which “health” is an associated keyword. The keyword “health” is, therefore, implicitly found on this page. Thus, the detection type is “Navigation.” In this embodiment, the keyword score is a product of the keyword's PPC, narrowness factors, relatedness factors and detection type factor. As shown in the first five rows of Table 1, keyword scores for the five keywords implicitly found on this page are calculated.

The keyword “health” is found in the title 904 of the page. At 906, a second keyword score is calculated for the keyword “health,” this time with a detection type of “Page title.” This calculation is also shown in the last row of Table 1.

TABLE 1

| | | |
|---|---|---|
| Score (health) | 0.85 × 1.0 × 0.4 × 0.25 = 0.09 | (Navigation) |
| Score (diet) | 1.16 × 0.9 × 1.0 × 0.25 = 0.26 | (Navigation) |
| Score (nutrition) | 1.03 × 1.0 × 0.9 × 0.25 = 0.23 | (Navigation) |
| Score (weight loss) | 1.43 × 1.6 × 1.25 × 0.25 = 0.72 | (Navigation) |
| Score (recipe) | 1.16 × 0.7 × 0.7 × 0.25 = 0.14 | (Navigation) |
| Score (health) | 0.85 × 1.0 × 0.4 × 0.9 = 0.31 | (Page title) |

At 908, cumulative relevance scores are calculated for the keyword “health.” Because this is the user's first browse, the score log contains no previously calculated keyword scores. The history weighting factor for the currently displayed page is 1, as shown in FIG. 7. Table 2 shows calculations of cumulative relevance scores for all five keywords.

TABLE 2

| | |
|---|---|
| Relevance (health) | (0.09 + 0.31) × 1 = 0.40 |
| Relevance (diet) | 0.26 × 1 = 0.26 |
| Relevance (nutrition) | 0.23 × 1 = 0.23 |
| Relevance (weight loss) | 0.72 × 1 = 0.72 |
| Relevance (recipe) | 0.14 × 1 = 0.14 |

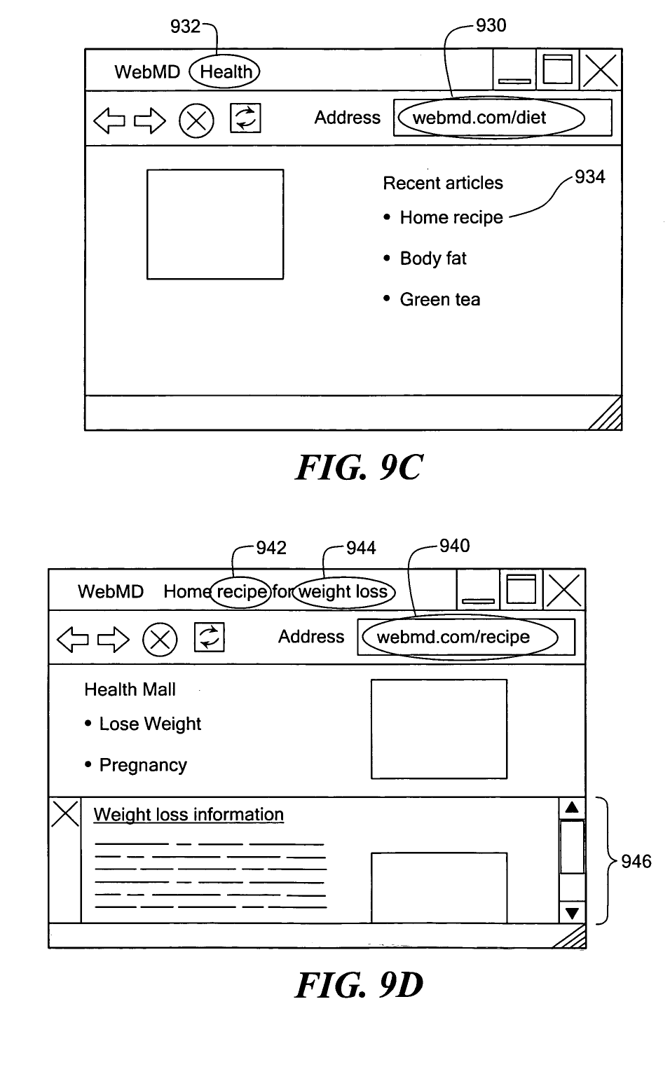

In this embodiment the lower of the two thresholds is 0.75, and the higher threshold is 2.0. Since none of the cumulative relevance scores exceeds either threshold, no advertisement is displayed. FIG. 10 shows an exemplary subset of the score log 212 produced by this example. The keywords and keyword scores calculated above, along with an “end of page” mark, are stored in the score log at 1000.

Returning to FIG. 9A, assume the user invokes a hyperlink at 910 to navigate to the page shown on FIG. 9B. The domain 920 of the page shown in FIG. 9B is the same as the domain of the previous page, i.e. “webmd.com,” thus the page category is “health,” and the same five keywords are used. As shown in the first five rows of Table 3, keyword scores for the five keywords implicitly found on this page are calculated, as they were in FIG. 9A. The keyword “health” is found in the title 922 of the currently displayed page, however this keyword is also found in the hyperlink 910 (FIG. 9A) that the user invoked to navigate to the current page. Thus, as shown at 924 (FIG. 9B) and in row six of Table 3, the detection type factor is 0 for the keyword “health” in the title, and the resulting keyword score is 0. However, the detection type factor is 0.9 for the keyword “health” in the hyperlink 910 (FIG. 9A), so as shown at 926 (FIG. 9B) and in row seven of Table 3, a keyword score of 0.34 is calculated for this invoked hyperlink.

TABLE 3

| | | |
|---|---|---|
| Score (health) | 0.85 × 1.0 × 0.4 × 0.25 = 0.09 | (Navigation) |
| Score (diet) | 1.16 × 0.9 × 1.0 × 0.25 = 0.26 | (Navigation) |
| Score (nutrition) | 1.03 × 1.0 × 0.9 × 0.25 = 0.23 | (Navigation) |
| Score (weight loss) | 1.43 × 1.6 × 1.25 × 0.25 = 0.72 | (Navigation) |
| Score (recipe) | 1.16 × 0.7 × 0.7 × 0.25 = 0.14 | (Navigation) |
| Score (health) | 0.85 × 1.0 × 0.4 × 0.0 = 0 | (Page title + |
| | | clicked hyperlink) |
| Score (health) | 0.85 × 1.0 × 0.4 × 1.0 = 0.34 | (Clicked |
| | | hyperlink) |

As shown in FIG. 7, the history weighting factors for the current page and the previous page are both 1. As shown at 928 and in the first row of Table 4, a cumulative relevance score is calculated for the keyword “health.” Table 4 also show the cumulative relevance score calculations for the other four keywords. The cumulative relevance scores for the keywords “health” and “weight loss” exceed the lower threshold of 0.75, so advertisements related to these keywords are added to the passive display. The keywords and keyword scores calculated above, along with an “end of page” mark, are stored in the score log at 1002.

TABLE 4

| | |
|---|---|
| Relevance (health) | (0.09 + 0 + 0.34) × 1 + (0.09 + 0.31) × 1 = 0.83 |
| Relevance (diet) | 0.26 × 1 + 0.26 × 1 = 0.52 |
| Relevance (nutrition) | 0.23 × 1 + 0.23 × 1 = 0.46 |
| Relevance | 0.72 × 1 + 0.72 × 1 = 1.44 |
| (weight loss) | |
| Relevance (recipe) | 0.14 × 1 + 0.14 × 1 = 0.28 |

Returning to FIG. 9B, assume the user invokes a hyperlink at 930 to navigate to the page shown in FIG. 9C. The domain 930 of the page shown in FIG. 9C is the same as the domain of the previous page, i.e. “webmd.com,” thus the page category is “health,” and the same five keywords are used. As shown in the first five rows of Table 5, keyword scores for the five keywords implicitly found on this page are calculated, as they were in FIG. 9B. The keyword “health” is found in the title 932, so a keyword score is calculated for the navigation type “Page title,” as shown in row six of Table 5. The keywords “diet” and “nutrition” are found in the text of the hyperlink 930 (FIG. 9B) that the user invoked to navigate to the current page, so keyword scores are calculated for these keywords, as shown in the last two rows of Table 5.

TABLE 5

| | | |
|---|---|---|
| Score (health) | 0.85 × 1.0 × 0.4 × 0.25 = 0.09 | (Navigation) |
| Score (diet) | 1.16 × 0.9 × 1.0 × 0.25 = 0.26 | (Navigation) |
| Score (nutrition) | 1.03 × 1.0 × 0.9 × 0.25 = 0.23 | (Navigation) |
| Score (weight loss) | 1.43 × 1.6 × 1.25 × 0.25 = 0.72 | (Navigation) |
| Score (recipe) | 1.16 × 0.7 × 0.7 × 0.25 = 0.14 | (Navigation) |
| Score (health) | 0.85 × 1.0 × 0.4 × 0.9 = 0.31 | (Page title) |
| Score (diet) | 1.16 × 0.9 × 1.0 × 1.0 = 1.04 | (Clicked |
| | | hyperlink) |
| Score (nutrition) | 1.03 × 1.0 × 0.9 × 1.0 = 0.93 | (Clicked |
| | | hyperlink) |

As shown in FIG. 7, the history weighting factors for the current page and the previous page are both 1, and the history weighting factor for the page before the previous page is 0.6. As shown in Table 6, cumulative relevance scores are calculated for the keywords. The cumulative relevance scores for keywords “health,” “diet,” “nutrition” and “weight loss” exceed the lower threshold of 0.75, however advertisements for keywords “health” and “weight loss” were recently displayed, so no additional advertisements are displayed for these keywords. An adjustable parameter can control the frequency of advertisements for a given keyword. Advertisements for the other two keywords, “diet” and “nutrition,” are added to the passive display. The keywords and keyword scores calculated above, along with an “end of page” mark, are stored in the score log at 1004.

TABLE 6

| | |
|---|---|
| Relevance (health) | (0.09 + 0.31) × 1 + (0.09 + 0 + 0.31) × |
| | 1 + (0.09 + 0.31) × 0.6 = 1.04 |
| Relevance (diet) | (0.26 + 1.04) × 1 + 0.26 × 1 + 0.26 × 0.6 = 1.72 |
| Relevance (nutrition) | (0.23 + 0.93) × 1 + 0.23 × 1 + 0.23 × 0.6 = 1.53 |
| Relevance | 0.72 × 1 + 0.72 × 1 + 0.72 × 0.6 = 1.87 |
| (weight loss) | |
| Relevance (recipe) | 0.14 × 1 + 0.14 × 1 + 0.14 × 0.6 = 0.36 |

Returning to FIG. 9C, assume the user invokes a hyperlink 934 to navigate to the page shown in FIG. 9D. The domain 940 of the page shown in FIG. 9D is the same as the domain of the previous page, i.e. “webmd.com,” thus the page category is “health,” and the same five keywords are used. As shown in the first five rows of Table 7, keyword scores for the five keywords implicitly found on this page are calculated, as they were in FIG. 9C.

The keyword “recipe” is found in the title 942 of the currently displayed page, however this keyword is also found in the hyperlink 934 (FIG. 9C) that the user invoked to navigate to the current page. Thus, as shown in row six of Table 7, the detection type factor is 0 for the keyword “recipe” in the title, and the resulting keyword score is 0. The keyword “recipe” is found in the text of the hyperlink 934 (FIG. 9C) that the user invoked to navigate to the current page, so a keyword score is calculated for this keywords, as shown in the last row of Table 7. The keyword “weight loss” is found in the title 944, so a keyword score is calculated for the navigation type “Page title,” as shown in row seven of Table 7.

TABLE 7

| | | |
|---|---|---|
| Score (health) | 0.85 × 1.0 × 0.4 × 0.25 = 0.09 | (Navigation) |
| Score (diet) | 1.16 × 0.9 × 1.0 × 0.25 = 0.26 | (Navigation) |
| Score (nutrition) | 1.03 × 1.0 × 0.9 × 0.25 = 0.23 | (Navigation) |
| Score (weight loss) | 1.43 × 1.6 × 1.25 × 0.25 = 0.72 | (Navigation) |
| Score (recipe) | 1.16 × 0.7 × 0.7 × 0.25 = 0.14 | (Navigation) |
| Score (recipe) | 1.16 × 0.7 × 0.7 × 0.0 = 0.00 | (Page title + |
| | | clicked hyperlink) |
| Score (weight loss) | 1.43 × 1.6 × 1.25 × 0.9 = 2.57 | (Page title) |
| Score (recipe) | 1.16 × 0.7 × 0.7 × 1.0 = 0.57 | (Clicked |
| | | hyperlink) |

As shown in Table 8, cumulative relevance scores are calculated for the keywords. The cumulative relevance scores for all five keywords exceed the lower threshold of 0.75, however passive advertisements for keywords “health,” “diet,” “nutrition” and “weight loss” were recently displayed, so no additional passive advertisements are displayed for these keywords. An advertisement for the keyword “recipe” is added to the passive display. The cumulative relevance score for the keyword “weight loss” exceeds the higher threshold of 2.0, so an advertisement for this keyword is added to the active display 946. The keywords and keyword scores calculated above, along with an “end of page” mark, are stored in the score log at 1006.

TABLE 8

| | |
|---|---|
| health | 0.09 × 1 + (0.09 + 0.31) × 1 + (0.09 + 0 + 0.31) × |
| | 0.6 + (0.09 + 0.31) × 0.3 = 0.85 |
| diet | 0.26 × 1 + (0.26 + 1.04) × 1 + 0.26 × 0.6 +0.26 × 0.3 = 1.80 |
| nutrition | 0.23 × 1 + (0.23 + 0.93) × 1 + 0.23 × 0.6 + 0.23 × 0.3 = 1.60 |
| weight | (0.72 + 2.57) × 1 + 0.72 × 1 + 0.72 × 0.6 + 0.72 × 0.3 = 4.66 |
| loss | |
| recipe | (0.14 + 0 + 0.57) × 1 + 0.14 × 1 + 0.14 × |
| | 0.6 + 0.14 × 0.3 = 0.97 |

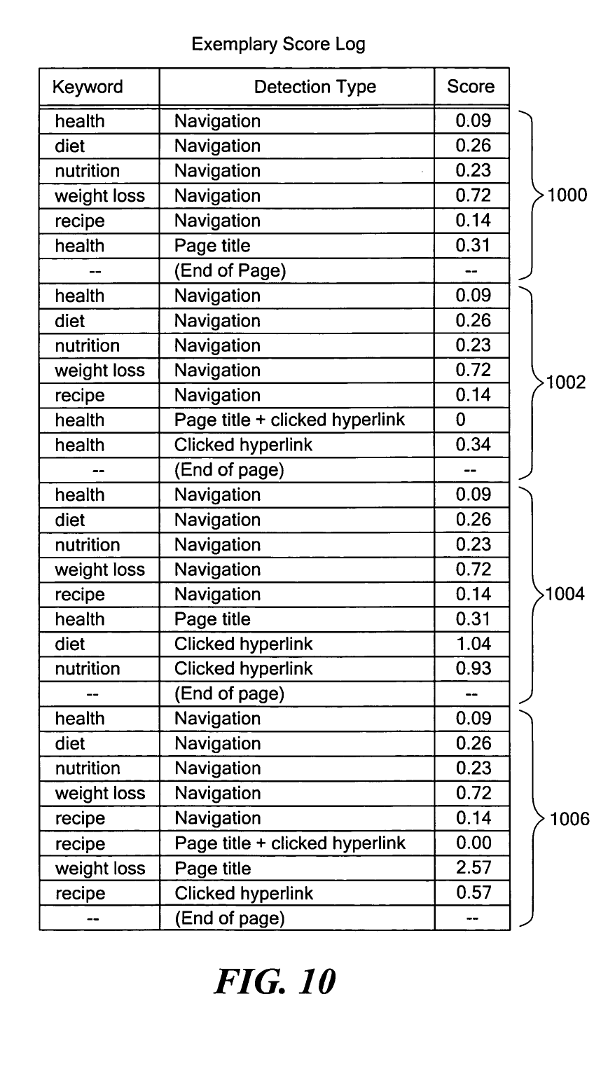

As noted, the database 210 (FIG. 2) can be updated periodically, occasionally or on command with new or changed page categories, keywords, etc. Updated information is received from a database update server over the Internet 202. To minimize the amount of data that is transferred over the Internet 202, preferably only changes to the database are sent, as is well-known in the art. FIG. 11 is a simplified flowchart illustrating a procedure for updating the database 210. At 1100, differences between the database and a desired updated database are determined. At 1102, these differences are sent to the client. At 1104, these differences are used to update the database.

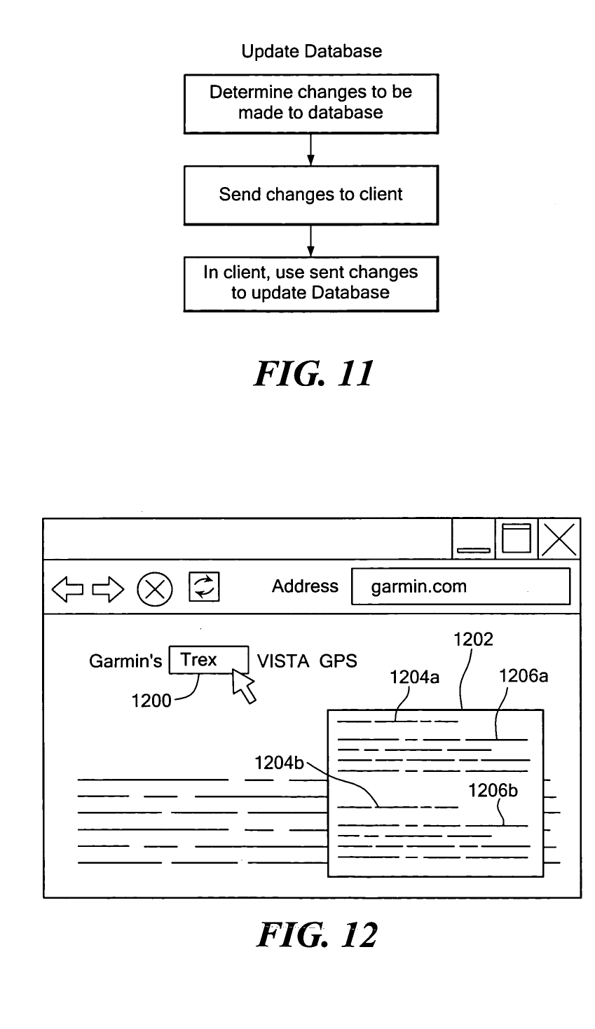

Returning to FIG. 2, another embodiment of the present invention analyzes data sent by the web server 204 to the browser 206 for display to the user. If this embodiment detects a keyword in text displayed by the browser 206, the embodiment displays a hyperlink, which the user can then invoke to display a related advertisement or visit an advertiser's page (in the current browser window or, preferably, in a separate browser window). An example interaction using this embodiment is illustrated in FIG. 12. In one embodiment, the detected text is highlighted, such as by changing its font color, background color or by bolding the text, as shown at 1200. If the user hovers a pointing device (e.g. a mouse) over the highlighted text, right-clicks the highlighted text or otherwise evidences interest in the highlighted text, the system displays a pop-up window 1202 that contains one or more hyperlinks 1204a and 1204b, as well as brief descriptions of the advertisements 1206a and 1206b. An advertisement server provides the brief descriptions and the hyperlinks. If the user invokes one of the hyperlinks 1204, the system displays a new browser window with a selected advertisement.

The various metrics (including thresholds) used by the system to calculate scores can be adjusted to improve performance of the system, i.e. make the system better able to ascertain topics of interest to users. These adjustments can be automatic or they can be made by a human. As noted, updated information can be downloaded from a database update server to the database. Thus, optimizations made or collected at a central location can be downloaded to clients. However, as described below, embodiments of the present invention are able to “tune” their metrics based on data captured by the clients from user behavior. These embodiments can also upload this information to the database update server for integration with similar information from other clients and subsequent downloading back to the clients.

Two possible factors that can be used to adjust these metrics are: (a) a frequency with which a user clicks on a hyperlink within an advertisement or otherwise expresses interest in the product or service being advertised (commonly referred to as a “click-through rate”) and (b) a frequency with which the user competes a transaction related to the advertisement (commonly referred to as a “conversion rate”). An advertiser can define “transaction.” For example, a transaction can be a purchase placed by the user for the advertised product or service. Other definitions of transactions depend on goals and objectives of the advertisers. Examples of transactions include: signing up to receive periodic electronic mailings from the advertiser; accepting a free sample from the advertiser; and agreeing to test a product (such as a test drive of a vehicle or acquiring a 30-day trial license for a software package).

A user's click-through and conversion rates correlate with the relevance of the advertisements displayed to the user. That is, the more relevant the advertisements, the more frequently the user expresses interest in an advertised product or service or purchases it. Therefore, measuring click-through and conversion rates facilitates identifying whether a system's metrics are displaying relevant advertisements to the user. These measurements also facilitate adjusting the system's metrics so more relevant advertisements are displayed to the user and fewer less relevant advertisements are displayed.

Embodiments of the present invention can capture click-through rates, because the user clicks on advertisements displayed on the client by software executing on the client, i.e. the advertisement presenter 220. Embodiments of the present invention can also capture conversion rates, because the database 210 can include URLs for transaction complete pages, such as “check-out” pages at e-commerce web sites. Thus, embodiments of the present invention can detect when a user competes a transaction by virtue of the fact that the user visits a transaction complete page. Advantageously, both types of rates can be collected solely by software executing on the client, unlike prior art systems that rely on “tracking pixels” or “cookies.” Collecting this data can, of course, be selectively enabled or disabled. For example, in light of privacy concerns of users, some embodiments collect this data only for select users who might have, for example, agreed to have this data collected in return for some compensation.

While the invention has been described with reference to a preferred embodiment, those skilled in the art will understand and appreciate that variations can be made while still remaining within the spirit and scope of the present invention, as described in the appended claims. For example, although embodiments were described in relation to displaying advertisements, any kind of information, message or display (collectively referred to herein as a “message”) can be provided. For example, an electronic library or research assistant could provide a message related to research begin conducted on the Internet or other on-line system. This message could include, for example, suggested facts to consider, sources to consult, definitions, synonyms, historical facts, current events, news or other publication articles or questions to ponder. In these cases, a message server (rather than an advertisement server) can provide the suggested facts, news articles, etc.

Although embodiments were described in relation to Internet web browsing, these and other embodiments are equally applicable to any on-line system in which a user interactively searches for data. The online system can be a private or a public system. A browser and a server that communicate using HyperText Transfer Protocol (HTTP) are not necessary, as long as the client obtains data from a server and aspects of the user's browsing can be obtained by the score calculator. For example, a proprietary query system, such as an electronic library index card system, that includes a client program that queries a database is amenable to being fitted with an embodiment of the present invention.

1. A method for displaying a contextual message on a client computer, comprising:
accumulating information related to a plurality of browses by the client on the client computer;
selecting a message based on the accumulated information; and
displaying the message on the client.

2. The method of claim 1, wherein the step of accumulating information comprises:
for each of the plurality of browses:
categorizing the browse; and
selecting at least one keyword based on the categorization.

3. The method of claim 1, wherein the step of accumulating information comprises:
identifying a keyword; and
calculating a score based on the keyword.

4. The method of claim 3, wherein the step of identifying a keyword comprises identifying a keyword associated with at least one of the plurality of browses.

5. The method of claim 3, wherein the step of accumulating information further comprises storing the identified keyword and the calculated score.

6. The method of claim 3, wherein the step of identifying a keyword comprises identifying a keyword associated with a source of data displayed as part of at least one of the plurality of browses.

7. The method of claim 3, wherein the step of identifying a keyword comprises identifying a keyword associated with a URL of data displayed as part of at least one of the plurality of browses.

8. The method of claim 3, wherein the calculating step comprises calculating the score based at least in part on an occurrence of the keyword in text associated with at least one of plurality of the browses.

9. The method of claim 8, wherein the calculating step comprises calculating the score based at least in part on a type of the occurrence of the keyword in the text.

10. The method of claim 8, wherein the calculating step comprises calculating the score based at least in part on an occurrence of the keyword in a title of the at least one of the plurality of browses.

11. The method of claim 8, wherein the calculating step comprises calculating the score based at least in part on an occurrence of the keyword in a hyperlink invoked as part of the at least one of the plurality of browses.

12. The method of claim 8, wherein the calculating step comprises calculating the score based at least in part on an occurrence of the keyword in a query entered as part of the at least one of the plurality of browses.

13. The method of claim 8, wherein the calculating step comprises calculating the score based at least in part on an occurrence of the keyword in text displayed on the client as part of the at least one of the plurality of browses.

14. The method of claim 13, wherein the displayed text is at least part of a web page.

15. The method of claim 13, wherein the accumulating step comprises determining the occurrence of the keyword in the displayed text by logic that is specific to at least one source of displayed text.

16. The method of claim 3, wherein the calculating step comprises:
calculating a plurality of scores, each score being based on an occurrence of the keyword in text associated with a respective one of the plurality of browses.

17. The method of claim 16, wherein the step of accumulating information further comprises storing the keyword and the plurality of calculated scores.

18. The method of claim 16, wherein the step of identifying a keyword comprises identifying a keyword associated with a source of data displayed as part of the at least one of the plurality of browses.

19. The method of claim 16, wherein the step of identifying a keyword comprises identifying a keyword associated with a URL of data displayed as part of at least one of the plurality of browses.

20. The method of claim 16, wherein the step of calculating a plurality of scores comprises basing each score on an occurrence of the keyword in text associated with a respective one of the plurality of browses.

21. The method of claim 16, wherein the step of calculating a plurality of scores comprises basing each score at least in part on an occurrence of the keyword in a title of a respective one of the plurality of browses.

22. The method of claim 16, wherein the step of calculating a plurality of scores comprises basing each score at least in part on an occurrence of the keyword in a hyperlink invoked as part of a respective one of the plurality of browses.

23. The method of claim 16, wherein the step of calculating a plurality of scores comprises basing each score at least in part on an occurrence of the keyword in a query entered as part of a respective one of the plurality of browses.

24. The method of claim 16, wherein the step of calculating a plurality of scores comprises basing each score at least in part on an occurrence of the keyword in text displayed on the client as part of a respective one of the plurality of browses.

25. The method of claim 24, wherein each displayed text is at least part of a web page.

26. The method of claim 24, wherein the accumulating step comprises determining the occurrence of the keyword in the displayed text by logic that is specific to at least one source of displayed text.

27. The method of claim 16, wherein the step of selecting the message comprises:
calculating a keyword relevance from the plurality of scores; and
if the keyword relevance exceeds a threshold, selecting the message based on the keyword.

28. The method of claim 27, wherein:
each browse is associated with a position within the plurality of browses;
each score is associated with the position associated with the browse from which the score was calculated; and
the step of calculating the keyword relevance comprises weighting each of the plurality of scores based on the position associated with the respective score.

29. The method of claim 1, wherein the step of displaying the selected message comprises displaying the selected message in a scrollable region.

30. The method of claim 1, wherein the step of displaying the selected message comprises adding the selected message to a list of zero or more messages displayable within a single region.

31. The method of claim 1, wherein:
the client executes a browser to perform the plurality of browses; and
the step of displaying the selected message comprises displaying the selected message within a region of the browser.

32. The method of claim 31, wherein:
the client executes a browser to perform the plurality of browses; and
the step of displaying the selected message comprises displaying the selected message within a frame of the browser.

33. The method of claim 1, wherein the step of displaying the message comprises displaying an advertisement.

34. The method of claim 1, wherein:
the step of selecting a message comprises obtaining an advertisement from an advertisement server; and
the step of displaying the message comprises displaying the advertisement.

35. The method of claim 3, wherein the step of selecting a message comprises:
sending the keyword to a server; and
obtaining the message from the server in response to sending the keyword to the server.

36. The method of claim 35, wherein the step of obtaining the message from the server comprises obtaining an advertisement from the server.

37. A method for displaying a contextual message on a client computer, comprising:
accumulating information about a user's browsing behavior over time on the client computer;
identifying at least one topic of interest to the user based on the accumulated information;
selecting a message based on the identified at least one topic of interest; and
displaying the selected message on the client.

38. A system for displaying a contextual message, comprising:
a client computer;
a plurality of browsing activity analyzers on the client computer, each configured to contribute topic nominations; and
a relevance filter on the client and configured to analyze topic nominations related to a plurality of browses conducted by the client to determine if a message related to at least one of the topic nominations should be displayed.

39. The system of claim 38, further comprising:
a message selector configured to select a message based on an output from the relevance filter; and
a message presenter.

40. The system of claim 38, further comprising:
a database containing keywords, categories of data sources and data that correlates the keywords with the categories of data sources; and wherein
each activity analyzer uses at least some of the data in the database to contribute the topic nominations.

41. The system of claim 40, wherein at least one of the browsing activity analyzers is configured to search for an occurrence of at least one of the keywords in text associated with a user browse.

42. The system of claim 41, wherein the browsing activity analyzer is configured to search for an occurrence of the keyword in a title of the user browse.

43. The system of claim 41, wherein the browsing activity analyzer is configured to search for an occurrence of the keyword in a hyperlink invoked as part of the user browse.

44. The system of claim 41, wherein the browsing activity analyzer is configured to search for an occurrence of the keyword in a search query entered as part of the user browse.

45. The system of claim 41, wherein the browsing activity analyzer is configured to search for an occurrence of the keyword in text displayed as part of the user browse.

46. The system of claim 38, wherein the relevance filter utilizes weighting factors to discount topic nominations, based on ages of the topic nominations.

47. The system of claim 38, wherein the message presenter comprises a region within a browser window.

48. The system of claim 38, wherein the message presenter comprises a pop-under window.

49. The system of claim 39, wherein the message is an advertisement.
